(19) United States
(12) Patent Application Publication
(10) Pub. No.: US 2008/0100033 A1
(43) Pub. Date: May 1, 2008

(54) Method And Apparatus For Securing A Trailer To A Tow Vehicle

(75) Inventors: Charles M. Lynn, Enid, OK (US); David Jeff Johnson, Rowlett, TX (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(73) Assignee: Lynco Products, LLC, Enid, OK (US)

(21) Appl. No.: 11/865,186

(22) Filed: Oct. 1, 2007

Related U.S. Application Data
(60) Provisional application No. 60/827,508, filed on Sep. 29, 2006.

(51) Int. Cl. B60D 1/00

(52) U.S. Cl. 280/504

(57) ABSTRACT

An attachment for securing a trailer to a hitch assembly comprising a ball. The attachment comprises a base plate, a latch plate, and a latch assembly. The base attaches to a bottom side of the hitch assembly and comprises a substantially horizontal plate and two opposing vertical plates. The vertical plates define opposing apertures. The latch plate is pivots about the base plate about a substantially horizontal pivot axis. In a locked position the latch plate is substantially parallel to the horizontal plate of the base and on an opposite side of the ball from the horizontal plate. The latch assembly comprises a spring-loaded pin which pivotally connects the base to the latch plate, and locks the latch plate when substantially parallel to the horizontal plate. A lock pin extends through an aperture of the base and an aperture of the latch plate to further secure the latch plate.

### CROSS REFERENCE TO RELATED APPLICATION

This application claims the benefit of U.S. Provisional Application No. 60/827,508, filed Sep. 29, 2006, the contents of which are incorporated herein fully by reference.

### FIELD OF THE INVENTION

The present invention is generally directed to the field of accessories for trailer hitches.

### SUMMARY OF THE INVENTION

The present invention is directed to an apparatus for securing a trailer to a tow vehicle. The trailer comprises a tongue. The tow vehicle comprises a hitch assembly. The apparatus comprises a generally horizontal base plate, a first vertical plate, a second vertical plate, a latch plate, and a latching assembly. The horizontal base plate has a first lateral edge and a second lateral edge opposite the first lateral edge. The base plate is connectable to the hitch assembly. The first vertical plate is attached to the first lateral edge of the base plate. The second vertical plate is attached to the second lateral edge of the base plate. The latch plate is pivotally connectible to the first vertical plate and the second vertical plate to form a pivot axis. The latch plate is movable between a locked position and an unlocked position about the pivot axis. The latching assembly is adapted to secure the latch plate in the locked position so the latch plate is substantially parallel to the horizontal base plate to secure the hitch assembly between the latch plate and the horizontal plate.

Another aspect of the present invention is directed to a method for securing a trailer to a hitch assembly. The trailer comprises a trailer tongue. The hitch assembly is connected to a tow vehicle. The method comprises providing a latch assembly, connecting the trailer tongue to the hitch assembly, moving the latch assembly to the locked position, and securing the latch assembly in the locked position. The latch assembly comprises a latch plate movable between a locked position and an unlock position. The latch assembly is formed to allow movement of the trailer tongue through 180 degrees of a vertical pivot axis defined by the hitch assembly. The latch assembly is moved to the locked position so that the trailer tongue is disposed within the latch assembly and prevented from disconnecting from the hitch assembly. The latch assembly is secured in the locked position with a spring biased pin and a secondary locking member.

Yet another aspect of the present invention is directed to an apparatus for securing a trailer to a tow vehicle. The trailer comprises a tongue. The tow vehicle comprises a hitch assembly. The apparatus comprises a generally horizontal base plate, a first substantially L-shaped vertical plate, a second substantially L-shaped vertical plate, a latch plate, and a latching assembly. The base plate has a first lateral edge and a second lateral edge opposite the first lateral edge. The base plate is connectable to the hitch assembly. The first substantially L-shaped vertical plate is attached to the first lateral edge of the base plate. The second substantially L-shaped vertical plate is attached to the second lateral edge of the base plate. The latch plate is pivotally connectible to the first vertical plate and the second vertical plate to form a pivot axis. The latch plate is movable between a locked position and an unlocked position about the pivot axis. The latching assembly is adapted to secure the latch plate in the locked position so the latch plate is substantially parallel to the horizontal base plate to secure the hitch assembly between the latch plate and the horizontal plate.

The present invention is also directed to an apparatus for securing a trailer to a tow vehicle. The trailer comprises a tongue. The tow vehicle comprises a hitch assembly. The apparatus comprises a generally horizontal base plate, a first vertical plate, a second vertical plate, a latch plate, and a spring-biased pin. The base plate has a first lateral edge and a second lateral edge opposite the first lateral edge. The base plate is connectable to the hitch assembly. The first vertical plate is attached to the first lateral edge of the base plate. The second vertical plate is attached to the second lateral edge of the base plate. The latch plate is pivotally connectible to the first vertical plate and the second vertical plate to form a pivot axis. The latch plate is movable between a locked position and an unlocked position about the pivot axis. The spring biased pin is adapted to secure the latch plate in the locked position so the latch plate is substantially parallel to the horizontal base plate to secure the hitch assembly between the latch plate and the horizontal plate.

The present invention is also directed to an apparatus for securing a trailer to a tow vehicle. The trailer comprises a tongue. The tow vehicle comprises a hitch assembly. The apparatus comprises a generally horizontal base plate, a first vertical plate, a second vertical plate, a latch plate, and a latching assembly. The base plate has a first lateral edge and a second lateral edge opposite the first lateral edge. The base plate is connectable to the hitch assembly. The first vertical plate is attached to the first lateral edge of the base plate. The second vertical plate is attached to the second lateral edge of the base plate. The latch plate is pivotally connectible to the first vertical plate and the second vertical plate to form a pivot axis. The latch plate is movable between a locked position and an unlocked position about the pivot axis. The latching assembly is adapted to secure the latch plate in thee locked position so the latch plate is substantially parallel to the horizontal base plate to secure the hitch assembly between the latch plate and the horizontal plate. The first and second vertical plates and the latch plate are formed to allow the trailer tongue to pivot about a vertical pivot axis formed by the hitch assembly. The trailer tongue pivots through 180 degrees relative to the tow vehicle.

### BRIEF DESCRIPTION OF THE DRAWINGS

FIG. 1 is a perspective view of a trailer hitch assembly showing an apparatus for securing a trailer to a tow vehicle in accordance with the present invention.

FIG. 2 is a bottom view of a base plate of the apparatus shown in FIG. 1.

FIG. 3 is a side view of the apparatus shown in FIG. 1 having a trailer tongue secured to a hitch assembly and wherein the apparatus of the present invention is shown in a locked position.

### DETAILED DESCRIPTION OF THE DRAWINGS

The present invention is directed to an attachment for a trailer hitch. A common problem with common trailer hitch apparatus is that the ball of the trailer hitch and the tongue of the trailer may become disconnected when the trailer is in tow or when the tow vehicle crosses rough terrain, such as cattle guards, potholes, etc. The disconnection may be caused when an upward force is present on the tongue, overcoming the force of the gripping mechanism and causing the tongue to “pop” off of the trailer hitch assembly. Unplanned disconnection of the trailer from the tow vehicle creates a safety hazard to other vehicles and bystanders or operators.

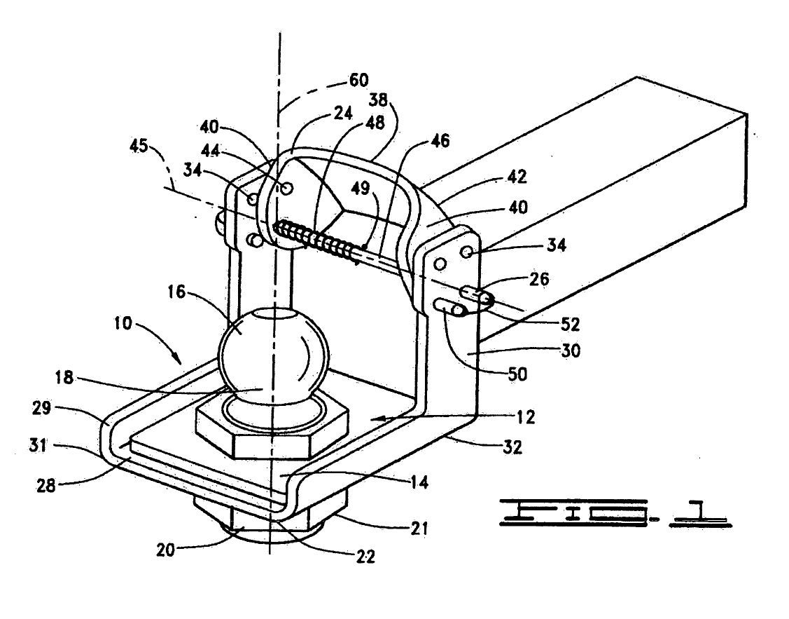

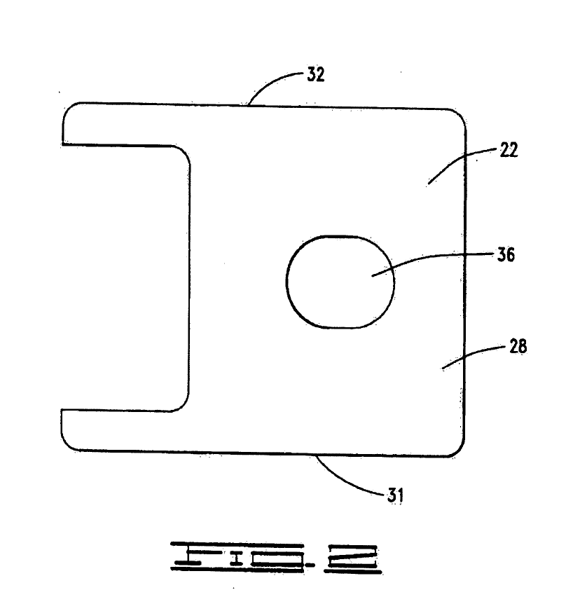

The present invention, shown in FIG. 1, is directed to an attachment 10, or latch assembly, for a trailer hitch assembly 12. A hitch assembly 12 generally comprises a tow vehicle connection frame 14 and a connection point 16. The frame 14 is fixedly attached to and extends from a back end of a tow vehicle. The connection point 16 is fixedly attached to the frame 14 and connectable to a trailer or other attachment. As shown, the connection point 16 comprises a ball hitch 18. The connection point 16 further comprises a fastener 20 such as a not and washer 21 or similar attachment means for attachment through a connection gap (FIG. 2) in the frame 14. A trailer (not shown) commonly comprises a tongue, wherein the tongue is adapted to cover the ball 18 of the trailer hitch 12. A gripping mechanism within the tongue then is applied to hold the tongue to the ball hitch 18.

The attachment 10 comprises a base 22, a latch plate 24, and a latching assembly 26. Preferably, the attachment 10 is made of steel, though alternative materials may be utilized that have the strength to secure a trailer to the trailer hitch assembly 12. The base 22 comprises a horizontal plate 28 and a first 29 and second 30 opposing vertical plate. Preferably, the opposing vertical plates 29, 30 may be substantially L-shaped as shown. The L-shape of the opposing vertical plates 29, 30 allows 180 degree pivotal movement of a trailer tongue about a pivot axis defined by the connection point 16 of the hitch assembly 12. Each of the opposing vertical plates 29, 30 are fixedly attached to the horizontal plate 28 at first 31 and second 32 lateral edges. The horizontal plate 28 and the first 29 and second 30 opposing vertical plates may be integrally formed. Additionally, the lateral edges 31, 32 may be rounded such that thicknesses of the vertical 29, 30 and horizontal 28 plates are uniform. The opposing vertical plates 29, 30 each define a plurality of opposing apertures 34. Preferably, the plurality of apertures 34 is arranged in one or more pairs.

The base 22 is adapted to attach to the frame 14 such that the horizontal plate 28 of the base is placed under the frame. As shown in FIG. 2, the horizontal plate 28 defines a connection gap 36. The connection gap 36 of the horizontal plate 28 is sized such that the ball hitch 18 may fit through the frame 14 and the connection gap 36 of the horizontal plate 28. The base 22 may be secured to the frame 14 by connecting the ball hitch 18 through the frame 14 and the connection gap 36 of the base 22 and securing the ball hitch 18 with the fastener 20 or other similar attachment means.

With reference again to FIG. 1, the latch plate 24 comprises a cover plate 38 and two opposed attachment plates 40. The cover plate 38 is fixedly attached to the two opposed attachment plates 40 at edges 42. Preferably, the edges 42 are rounded such that thicknesses of the attachment plates 40 and cover plate 38 are uniform. Preferably, the distance between the two opposed attachment plates 40 is just smaller than the distance between the two opposed vertical plates 29, 30 of the base 22. Each of the two opposed attachment plates defines at least one aperture 44. The latch plate 24 is movable between a locked position and an unlocked position. When in the locked position, the cover plate 38 is substantially parallel to the horizontal plate 28 of the base 22. When in the unlocked position (as shown in FIG. 1), the cover plate 38 is movable about a pivot axis 45.

The latching assembly 26 is adapted to connect the latch plate 24 to the base 22. The latching assembly 26 comprises a latch pin 46, a spring 48, a restraining member 49, and a secondary locking member, or lock pin 50. Preferably, the latch pin 46 is placed through one pair of the apertures 34 on the opposed vertical plates 29, 30 of the base 22 and through one pair of the apertures 44 on the opposed attachment plates 40 of the latch plate 24. In this configuration, the latch plate 24 is pivotally connected to the base 12 about the latch pin 46.

The latch pin 46 comprises an engaged and a disengaged position. The latch pin 46 may be curved such that it can extend through a third aperture 34 of one of the vertical plates 29, 30 and a third aperture 44 of one of the attachment plates 40 when in the engaged position. The spring 48 is adapted to bias the latch pin 46 to the engaged position. Preferably, the spring 48 is dispersed about the latch pin 46 and between one of the attachment plates 40 and a restraining member 49. The restraining member 49 may comprise a pin, fixedly attached to the latch pin 46. When the latch pin 48 is in an engaged position, the cover plate 38 defines a plane that is substantially parallel to the horizontal plate 28 of the base 22. In this configuration, the hitch assembly or trailer hitch 12 is disposed between the latch plate 24 and the horizontal plate 28 and secured there between.

The lock pin 50 is adapted to connect a fourth aperture 34 of the base 22 to a fourth aperture 44 of the latch plate 24. The lock pin 50 holds the latch plate 24 in place when the latch pin 46 is in a disengaged position. Preferably, the lock pin 50 may be attached to the latch pin by a cord 52. When the latch pin 46 is in the engaged position, or the lock pint 50 is engaged, the latch plate 24 is in the locked position. When the lock pin 50 is disengaged and the latch pin 46 is in the disengaged position, the latch plate 24 is in the unlocked position and moveable about the pivot axis, which is generally collinear with at least a portion of the latch pin 46 of the latching assembly 26.

As shown, the plurality of apertures 34 on each of the first 29 and second 30 opposing vertical plates comprise three pair of two horizontally-aligned apertures. This allows the latch assembly 26 and latch plate 24 to be set at three different levels relative to the base 22, depending upon the dimensions of the ball hitch 18 or the particular trailer used.

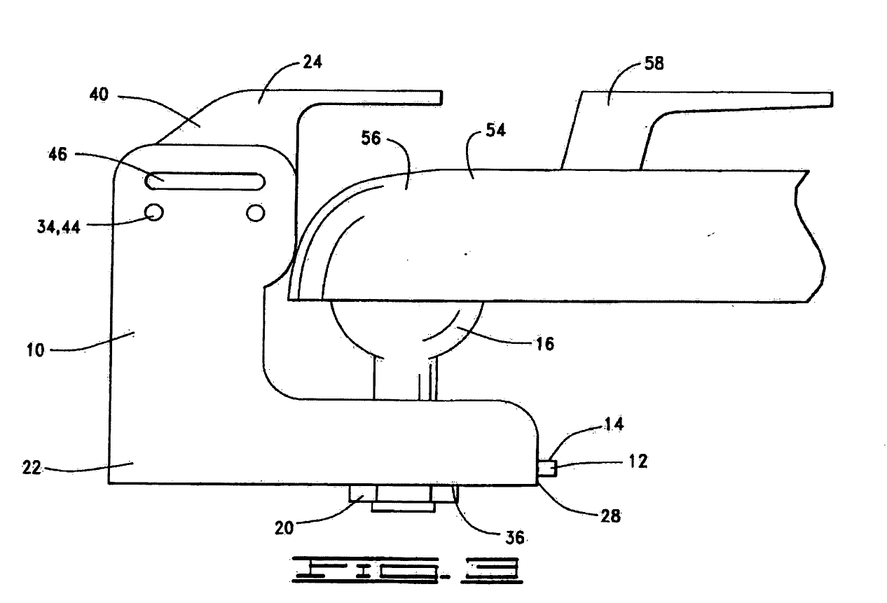

Turning now to FIG. 3, a trailer 54 comprising a trailer tongue 56 and a gripping assembly 58 may be secured to a trailer hitch assembly 12 utilizing the attachment 10. The tongue 56 of the trailer 54 may be placed over the ball hitch 18 and secured with the gripping assembly 58.

In operation, the latch assembly 26 is movable between a locked position and an unlocked position. The latch assembly 26 is formed to allow movement of the trailer tongue 56 through 180 degrees of a vertical pivot axis 60 defined by the hitch assembly 12. The trailer tongue 56 is then connected to the hitch assembly 14. the latch assembly 26 is moved to the locked position so that the trailer tongue 56 is disposed within the latch assembly 26 and prevented from disconnecting from the hitch assembly 12. The latch assembly is then secured in the locked position with the spring-biased latch pin 46 and the lock pin 50. In this configuration, the cover plate 38 and horizontal plate 28 are substantially parallel and disposed about the ball hitch 18 and trailer tongue 56. Moving the latch assembly to the unlocked position comprises removing the spring-biased latch pin 46 from at least one aperture 44 formed in the latch plate 24.

The attachment 10 is secured to the trailer hitch assembly 12 by removing the ball hitch 18 or other connection point from the frame 14 of the trailer hitch assembly 12. The attachment 10 is then placed with the horizontal plate 28 of the base 22 underneath the frame 14 of the trailer hitch assembly 12, with the connection gap 36 generally below the location at which the ball hitch 18 is attached to the frame 14 of the trailer hitch assembly 12. The latch plate 24 is in the unlocked position. The ball hitch 18 is then re-attached to the frame 14 through the connection gap 24. The fastener 20 may be used to tighten the ball hitch 18 to the frame 14 and the base 22 of the attachment 10 to the hitch assembly 12.

The trailer 54 may be disengaged in a similar manner. First, the lock pin 50 is removed and the latch pin 46 is disengaged. The latch plate 24 may then be moved to an unlocked position by removing the latch pin 46 from at least one aperture formed in one of the vertical plates 29, 30. The gripping assembly 58 may be disengaged and the tongue 56 removed from the ball hitch 18.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

1. An apparatus for securing a trailer, comprising a tongue, to a tow vehicle, wherein the tow vehicle comprises a hitch assembly, the apparatus comprising:
a generally horizontal base plate having a first lateral edge and a second lateral edge opposite the first lateral edge; wherein the base plate is connectable to the hitch assembly;
a first vertical plate attached to the first lateral edge of the base plate;
a second vertical plate attached to the second lateral edge of the base plate;
a latch plate pivotally connectible to the first vertical plate and the second vertical plate to form a pivot axis wherein the latch plate is movable between a locked position and an unlocked position about the pivot axis; and
a latching assembly, adapted to secure the latch plate in the locked position so that the latch plate is substantially parallel to the horizontal base plate to secure the hitch assembly between the latch plate and the horizontal plate.

2. The apparatus of claim 1, wherein the first and second vertical plates are substantially L-shaped to allow pivotal movement of the trailer tongue about a pivot axis defined by the hitch assembly.

3. The apparatus of claim 2 wherein the latch plate comprises a cover plate adapted to secure the trailer tongue to the hitch assembly when the latch plate is in the locked position.

4. The apparatus of claim 1 wherein the trailer may pivot 180 degrees about a pivot axis defined by the hitch assembly and within a plane defined by the trailer tongue.

5. The apparatus of claim 1 wherein the latching assembly comprises a pin adapted to pass through an aperture formed in each of the first and second vertical plates and corresponding apertures formed in the latch plate.

6. The apparatus of claim 5 wherein the pin defines the pivot axis formed between the first and second vertical plates and the latch plate.

7. The apparatus of claim 6 wherein the pin further comprises a spring disposed between the first vertical plate and a restraining member supported on the pin, wherein the spring biases the pin into the apertures formed in the first and second vertical plates and the latch plate.

8. The apparatus of claim 6 further comprising a secondary locking member adapted to secure the latch plate in the locked position.

9. The apparatus of claim 1 wherein the hitch assembly comprises a ball hitch.

10. The apparatus of claim 1 wherein the hitch assembly comprises a tow vehicle connection frame and a ball hitch connected to the tow vehicle connection frame with a fastener, wherein the horizontal base plate is connected to the ball hitch and tow vehicle connection frame with the fastener.

11. A method for securing a trailer, comprising a trailer tongue, to a hitch assembly connected to a tow vehicle, the method comprising:
providing a latch assembly comprising a latch plate movable between a locked position and an unlock position; wherein the latch assembly is formed to allow movement of the trailer tongue through 180 degrees of a vertical pivot axis defined by the hitch assembly;
connecting the trailer tongue to the hitch assembly;
moving the latch assembly to the locked position so that the trailer tongue is disposed within the latch assembly and prevented from disconnecting from the hitch assembly; and
securing the latch assembly in the locked position with a spring biased pin and a secondary locking member.

12. The method of claim 11 wherein moving the latch assembly to the unlock position comprises removing the spring biased pin from at least one aperture formed in the first vertical plate and an aperture formed in the latch plate.

13. An apparatus for securing a trailer, comprising a tongue, to a tow vehicle, wherein the tow vehicle comprises a hitch assembly, the apparatus comprising:
a generally horizontal base plate having a first lateral edge and a second lateral edge opposite the first lateral edge; wherein the base plate is connectable to the hitch assembly;
a first substantially L-shaped vertical plate attached to the first lateral edge of the base plate;
a second substantially L-shaped vertical plate attached to the second lateral edge of the base plate;
a latch plate pivotally connectible to the first vertical plate and the second vertical plate to form a pivot axis; wherein the latch plate is movable between a locked position and an unlocked position about the pivot axis; and
a latching assembly, adapted to secure the latch plate in the locked position so that the latch plate is substantially parallel to the horizontal base plate to secure the hitch assembly between the latch plate and the horizontal plate.

14. An apparatus for securing a trailer, comprising a tongue, to a tow vehicle, wherein the tow vehicle comprises a hitch assembly, the apparatus comprising:
a generally horizontal base plate having a first lateral edge and a second lateral edge opposite the first lateral edge; wherein the base plate is connectable to the hitch assembly;
a first vertical plate attached to the first lateral edge of the base plate;
a second vertical plate attached to the second lateral edge of the base plate;
a latch plate pivotally connectible to the first vertical plate and the second vertical plate to fort a pivot axis; wherein the latch plate is movable between a locked position and an unlocked position about the pivot axis; and
a spring biased pin adapted to secure the latch plate in the locked position so that the latch plate is substantially parallel to the horizontal base plate to secure the hitch assembly between the latch plate and the horizontal base plate.

15. The apparatus of claim 14, wherein the first and second vertical plates are substantially L-shaped to allow pivotal movement of the trailer tongue about a pivot axis defined by the hitch assembly.

16. The apparatus of claim 14 wherein the spring biased pin is adapted to pass through a plurality of apertures formed in the first vertical plate, at least one aperture formed in the second vertical plate, and corresponding apertures formed in the latch plate to secure the latch plate in the locked position.

17. The apparatus of claim 16 further comprising a secondary locking member adapted to pass through a second aperture formed in the second vertical plate and a corresponding aperture formed in the latch plate to secure the latch plate in the locked position.

18. An apparatus for securing a trailer, comprising a tongue, to a tow vehicle, wherein the tow vehicle comprises a hitch assembly, the apparatus comprising:
a generally horizontal base plate having a first lateral edge and a second lateral edge opposite the first lateral edge; wherein the base plate is connectable to the hitch assembly;
a first vertical plate attached to the first lateral edge of the base plate;
a second vertical plate attached to the second lateral edge of the base plate;
a latch plate pivotally connectible to the first vertical plate and the second vertical plate to form a pivot axis; wherein the latch plate is movable between a locked position and an unlocked position about the pivot axis; and
a latching assembly, adapted to secure the latch plate in the locked position so that the latch plate is substantially parallel to the horizontal base plate to secure the hitch assembly between the latch plate and the horizontal plate;
wherein the first and second vertical plates and the latch plate are formed to allow the trailer tongue to pivot about a vertical pivot axis formed by the hitch assembly through 180 degrees relative to the tow vehicle.

19. The apparatus of claim 18 wherein the latching assembly comprises a pin adapted to pass through an aperture formed in each of the first and second vertical plates and corresponding apertures formed in the latch plate.

20. The apparatus of claim 18 wherein the hitch assembly comprises a tow vehicle connection frame and a ball hitch connected to the tow vehicle connection member with a fastener, wherein the horizontal base plate is connected to the ball hitch with the fastener.
